(19) United States
(12) Patent Application Publication
(10) Pub. No.: US 2008/0128454 A1
(43) Pub. Date: Jun. 5, 2008

(54) Dispensing Appliance and Cartridge Therefor

(76) Inventor: Clifford Edward Beckett, Berks (GB)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/886,029

(22) PCT Filed: Mar. 10, 2006
(86) PCT No.: PCT/GB06/00847

§ 371 Date: Feb. 21, 2008

(30) Foreign Application Priority Data
Mar. 10, 2005 (GB) 0504990.3

(51) Int. Cl. B67D 5/52

(52) U.S. Cl. 222/137

(57) ABSTRACT

A non-unity ratio cartridge for a dispensing gun for delivering (for example) binary components of a curable material. The outlet ports in the cartridge are compensated to provide equal flow velocities while at the same time ensuring they are dimensionally the same as between cartridges of different ratios such that the same nozzle attachment (for example) can be used on any of a set of cartridges of different ratios.

This invention relates to multiple barrelled dispensers for dispensing multiple-component materials. The invention also though not exclusively, relates to a multi-barrelled cartridge for such a dispensing arrangement.

Multiple barrelled cartridges (typically double-barrel) for dispensers are typically used to store the reactive components of a material. The cartridge is loaded into the dispenser in a way that allows the components to be discharged simultaneously. The components are dispensed through respective outlets in the cartridge barrels by means of pistons in the barrels which are acted on by an actuator mechanism of the dispenser.

For example, the barrels may contain components of a binary adhesive which cures upon mixing of the two components when they are discharged. Dispensers and cartridges of this type find use in many different applications. For example, they are used in dental applications for dispensing the binary components of an impression material or temporary filling material. The dispensed components of the material are mixed as they progress through a common mixer head attached to the cartridge which leads to an outlet nozzle.

A cartridge having barrels with equal cross-sectional areas dispenses material from each cartridge in equal amount for a given movement to the driving pistons (i.e., the dispensing ratio is 1:1 or unity). Different dispensing ratios are achieved by changing the cross-sectional area of one barrel with respect to the other, such that a different volume of material is dispensed from one of the barrels relative to the other for a given movement of the driving pistons.

Typically, the outlets from the barrels of a dispenser cartridge are in the form of projections from the ends of the barrels. These are not filled with component materials during the manufacturing process. Often, the outlets are blocked by means of plugs which extend into the projections. Thus, when the plugs are removed and the materials are first dispensed from the cartridge, the outlet projection of the smaller barrel will not fill at the same rate as that of the larger barrel. This leads to an unmixed amount of the component from the larger barrel reaching the outlet nozzle of the mixer head first. This requires the user to dispense an initial amount of the substance until the correct ratio of mixture of the two components is achieved. While the volume of substance is relatively small, it would be preferable if the material appearing at the outlet was reliably mixed from the start. Some users may not be aware of the problem and try to use the unmixed material. In a dental or other medical application, this could have particularly serious consequences.

Upon each use of the dispenser and cartridge assembly, the mixer head becomes filled with the mixed components which eventually react and set in the mixer head after use. Thus, the mixer attachment is discarded after each use and takes with it an amount of residual material. The attachment of the mixer to the cartridge is so arranged that small quantities of the components in the cartridge outlet projections are removed with the mixer head in order to prevent cross-contamination between the components in the outlets. A new mixer head has to be attached to the cartridge each time the cartridge is used. Given that a single cartridge may typically be used in the dental application around twenty or more times, this means twenty or more mixer heads, leading to a significant quantity of wasted mixer heads and material residing in each discarded mixer head.

Furthermore, extrusion of different volumes of material from each barrel per unit advancement of the pistons through outlet ports of the same cross-sectional area creates an imbalance in the work done on the pistons as they are advanced. This imbalance can lead to impaired actuator performance due to the different loads on the respective parts of the actuating mechanism acting on the two barrels.

Cartridges with non-unity ratio barrels mean that the pressure on the material extruded from the outlet of the larger barrel would be larger than that from the smaller barrel. This results in a back pressure in the mixing head which may be larger than the forward dispensing pressure applied to the material in the smaller barrel. As a result, there is also a risk of backflow of mixed material, thereby contaminating the outlet protrusion of the smaller barrel.

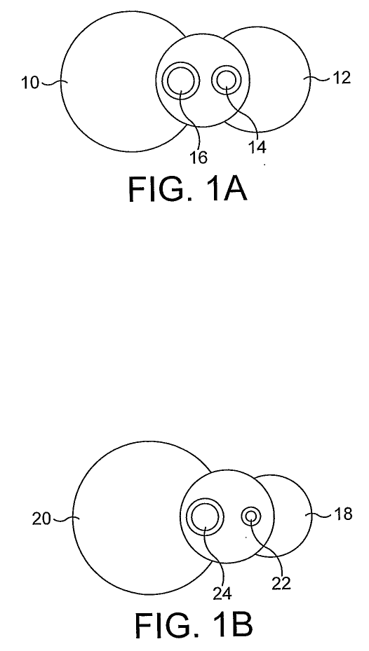

Proposed dispenser/cartridge/mixer assemblies have attempted to address this problem by providing differently sized apertures in the ends of the barrels to compensate for the non-unity ratio of the barrels themselves. This is shown schematically in FIGS. 1A and 1B of the drawings. Each is a cross-section through a cartridge comprising two barrels and a central portion in which the outlets from the two barrels are formed. In FIG. 1A, a 2:1 ratio cartridge is shown comprising barrels 10 and 12. It will be seen that the outlet orifices 14 and 16 are similarly proportioned according to the 2:1 ratio. FIG. 1B shows a 4:1 ratio cartridge comprising barrels 18 and 20 leading to outlets 22 and 24 having the same 4:1 ratio between their cross-sectional areas. In both cases, the local extrusion velocity at the barrel outlet is essentially the same for both barrels because the difference in volumetric dispensing rates is compensated for by the area of the aperture through which the materials are extruded. Thus, the volumes of the protruding outlets are similarly in a ratio of 4:1. Thus, the materials from both barrels reach the mixer head at substantially the same rate upon first use of the cartridge with a fresh nozzle.

However, the prior art cartridge has a significant disadvantage: since the apertures of the mixer head have to engage directly with the outlets from the barrels, it is necessary to manufacture and supply different mixer heads for each ratio of barrels making up the cartridges. Indeed, in prior art designs, the use of differently sized apertures has been used to provide a form of ‘coding’ of the cartridge and the mixer head so that they can only be connected in one orientation. This adds to the cost of the cartridge because the mixer heads have to be produced in quantities proportional to the cartridge each one fits.

The present invention is recited in the accompanying independent claims. Some preferred features are recited in the claims dependent thereon.

Embodiments of the present invention enable the same mixer head, or other attachment to the outlets of the cartridge, to be used on cartridges having barrels of different ratios. Because of this, the mixer head or other attachment can be produced in significantly greater quantities to be supplied with, or for, a range of different cartridges. Because in, for example, binary component material applications the mixer head is disposed of after one use, any cost saving in their production is a significant advantage.

Embodiments of the invention provide a set of cartridges such that the same attachment, for example a mixer head or a stopper, can be made to fit all ratios of cartridges in the set. This enables tooling production cost savings as only one version of each attachment type is required for the set.

The outlets may take various forms. In a particular embodiment they are formed by circular section projections from the end wall of the cartridge. In this case the projections on a cartridge may be of the same size and be the same between cartridges. To compensate for the different flow rates from the outlets on a cartridge, the outlet on a smaller cartridge may be fitted with an obstruction to reduce the cross section area of the outlet aperture. For example, a spigot can be arranged in the said outlet so that the outlet itself becomes annular. Generally speaking, it is the cross section area of that void of the outlet that is effective in compensating for the discharge rates from the two barrels where such compensation is used.

The engaging surfaces of the cartridge projection and the attachment for the cartridge are preferably cylindrical and circular in section, but could be any other shape and configuration that allows the interchangeability of the attachment with each of the cartridges in the set. Thus, rectangular section engagements are possible, but not preferred. Likewise, the preferred engagement is of the straight sided plug and socket type to provide for a suitable sealing engagement when the attachment is mounted on the cartridge. However, an outwardly tapered engaging surface on one of the cartridge and the attachment, and a complementary engaging surface on the other is equally possible. Another form of engagement may be by complementary mating (e.g. flat or part-spherical) surfaces that abut one another.

In another form of the invention the N:1 ratio cartridge has outlets with engaging surfaces that are of the same shape and lateral dimensions. The speed at which the components are dispensed from the barrels of such a cartridge is compensated by adjusting the size of the outlet within the similarly dimensioned engaging surfaces either by the size of the outlet itself or by the addition of a spigot or other encroachment on the cross section area.

The commonest forms of attachment to a cartridge of this type in many applications, such as dental and medical applications, is a mixer head by which the components from the barrels of the cartridge are mixed and dispensed from a nozzle. Another form of attachment for such a cartridge is a stopper which is applied to the cartridge when it is not in use. A stopper is simply a blanking plate which is shaped to engage with the outlets of the barrels of the cartridge.

The invention can be put into practice in various ways, some of which will now be described by way of example with reference to the accompanying drawings in which:

FIGS. 1A and 1B are end views of prior art double-barrel cartridges;

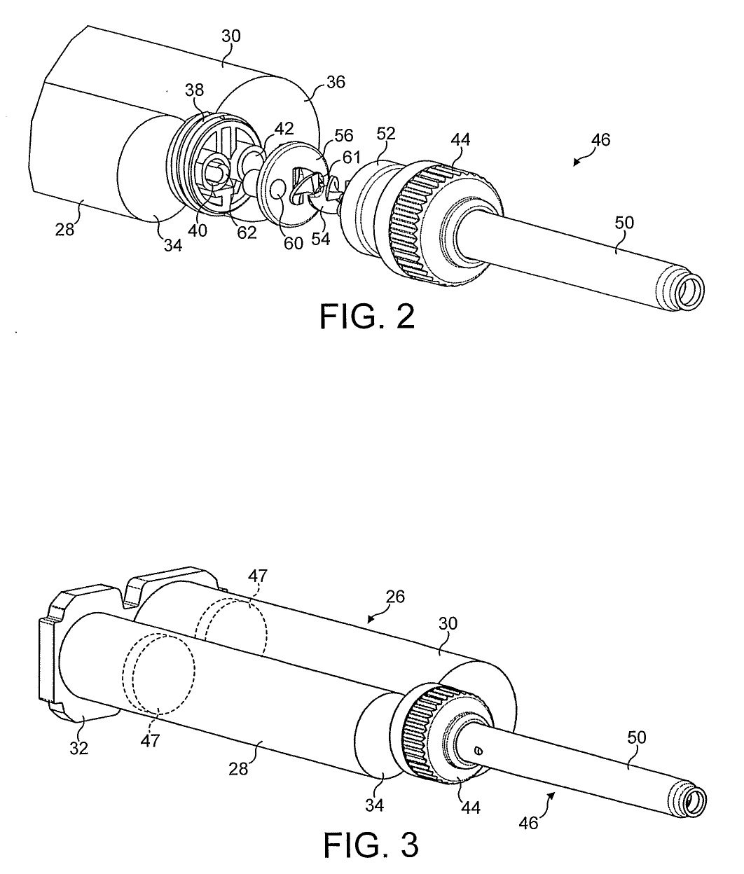

FIG. 2 is an illustration of the attachment of a mixer head to a cartridge according to the invention;

FIG. 3 shows a cartridge and nozzle assembly partly illustrated in FIG. 2;

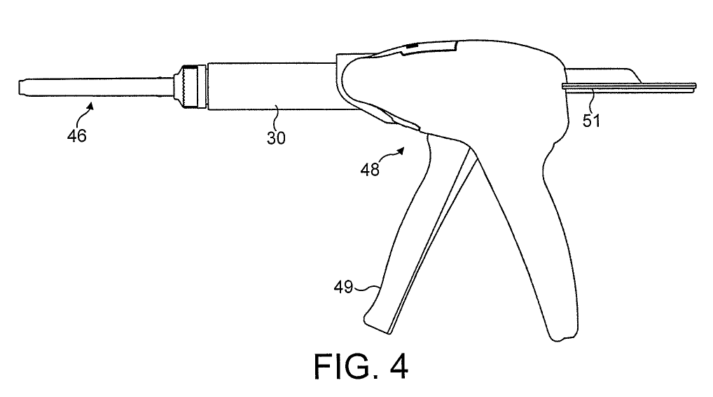

FIG. 4 is a dispensing gun including a cartridge and nozzle assembly as shown in FIG. 3;

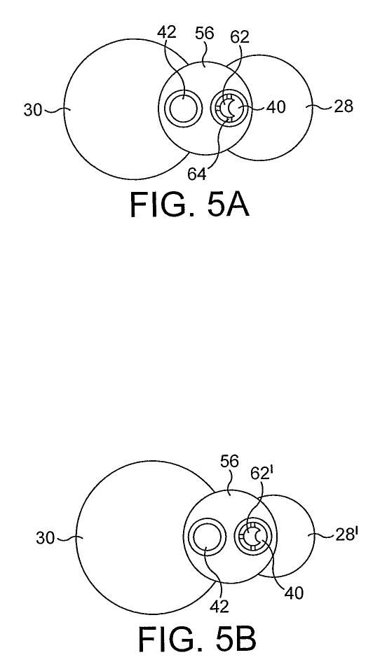

FIGS. 5A and 5B are end views of two cartridges according to embodiments of the present invention;

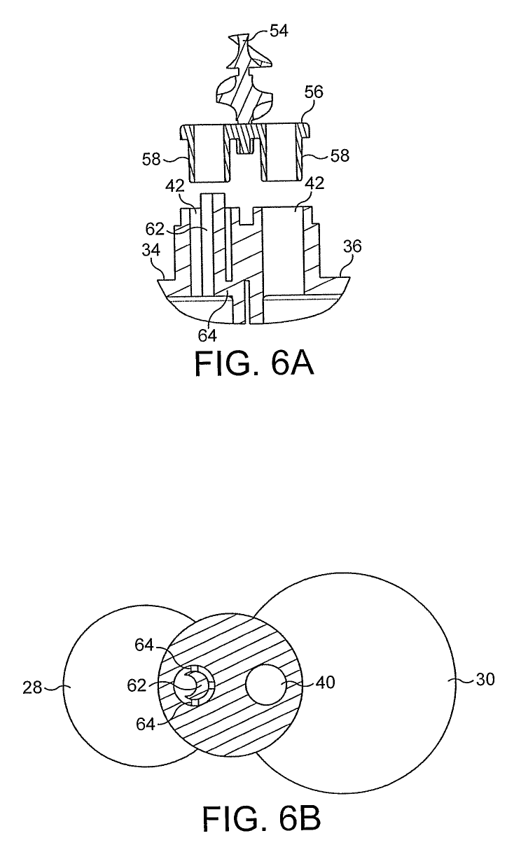

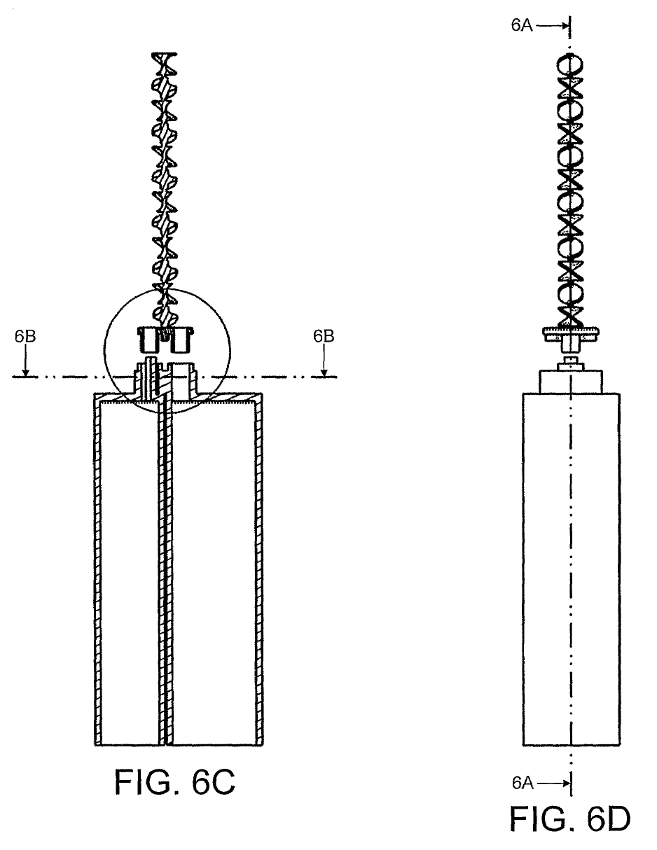

FIGS. 6A, 6B, 6C and 6D are views of a cartridge and attachment according to another embodiment of the present invention;

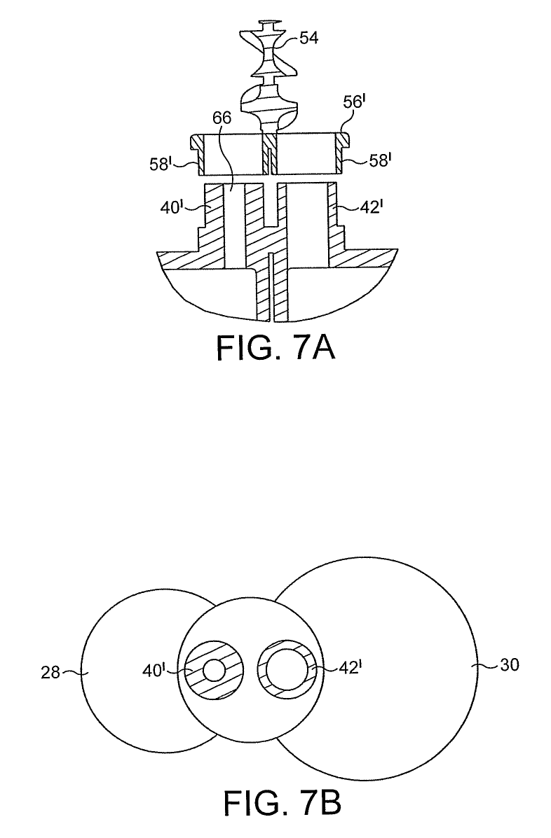

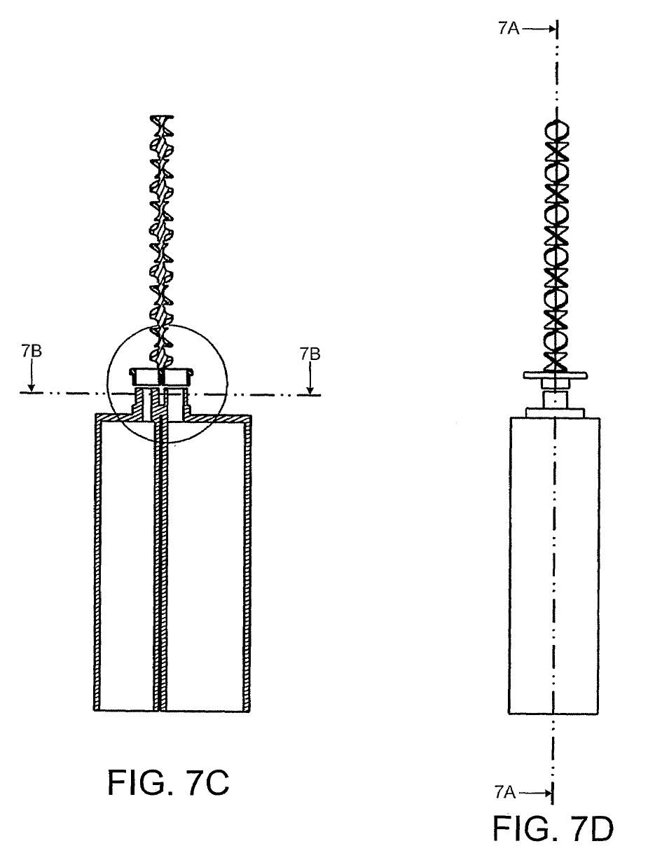

FIGS. 7A, 7B, 7C and 7D are views of a cartridge and attachment according to a further embodiment of the present invention.

Referring to FIGS. 2 and 3, a cartridge 26 for a dispenser comprises a pair of parallel uniformly circular section parallel barrels 28/30. The barrels are joined, at one end, by a retaining flange 32 which is integrally moulded in a rigid plastics material with the barrels and is the means by which the cartridge is engaged for use by the dispenser actuator.

At the one end, the barrels are open. At the other end, the barrels are each closed by an end wall 34/36. The end walls merge through an integral central circular port member 38 which defines a circular outlet port 40/42 from each barrel which extends through the respective end walls 34/36. The outer circumferential surface of the port member 38 is threaded to receive a retaining collar 44 which holds in place a mixing head 46.

A piston 47 is arranged inside each barrel. The materials dispensed from the barrels are stored in front of the pistons. The actuator mechanism 48 of the dispenser (see FIG. 4) is used to pump the materials by forcing the pistons along the barrels so that the materials are extruded through the outlet ports 40 and 42. The dispenser shown in FIG. 4 is based on a mechanical actuator using a trigger 49 to advance a pair of parallel piston rods engaging the pistons in the respective barrels. The actuator mechanism in this embodiment is based on a tooth and ratchet arrangement, driving rods 51 which engage the pistons 47. Alternative means of advancing the pistons include electrical motor-based arrangements, and pneumatically or hydraulically driven arrangements. Detail of the actuator mechanism has been omitted for the sake of clarity but will be well known to the person of ordinary skill in the art.

The mixer head 46, held in place on the cartridge by the retaining collar 44, comprises an elongate nozzle 50. The upstream end of the nozzle is arranged in the form of a flared skirt end 52 defining a mixing chamber. A static mixer device 54 is arranged inside the elongate nozzle 50. An adaptor plate 56 is arranged inside the skirt end 52 of the mixer head 46, providing an interface by which sealing engagement with the outlet ports of the barrels is achieved.

The adaptor plate 56 is a circular disc with two projections 58 (one of which is shown) arranged to register with the outlet ports 40 and 42 of the barrels. The projections are formed with respective apertures 60/61 by which fluid components in the barrels can pass through their respective ports and into the mixer head 46. While the adaptor plate 56 and the static mixer device 54 are shown as separate items, they can equally well be made as a single entity. Typically, they are manufactured from moulded rigid plastics material.

Referring particularly to FIGS. 2 and 5A, it will be seen that the outlet ports 40 and 42 from the barrels are uniformly circular in section and of the same diameter. The port 42 forms an unobstructed circular aperture of uniform internal diameter leading directly from the larger of the two barrels 30. In the case of FIG. 5A, the ratio of the cartridge barrels is 2:1. To establish even velocity flow rates from the outlet ports of the two barrels for a given piston movement, the outlet port for the smaller barrel 28 is arranged with a crescent section spigot 62. The spigot 62 extends along the length of the projecting port 40 from the smaller of the barrels 28. The cross-sectional area of the spigot 62 is arranged such that the cross-sectional area of the void thus defined within the cross-section of the port 40 is half the cross-sectional area of the void defined within the port 42. FIG. 5B illustrates the equivalent for a 4:1 ratio cartridge, having a smaller barrel 28′ and spigot 62′. The outer surfaces of the outlet ports 40 and 42 are of the same dimensions as those for the cartridge in FIG. 5A. Thus, the same attachment can be fitted to both cartridges.

Further detail of the arrangement of the spigot 62 within the port 40 is shown in FIG. 6A-D. It will seen that the spigot 62 is held in place by three arms 64 each extending radially to a fixing point on the inner surface defining the port 40. For manufacturing reasons the spigot is crescent shaped in section. The convex surface of the spigot is arcuate and centred on the same radius as the circular section of the outlet 40. Other sections are possible, such as a circular section.

Referring particularly to FIG. 6A-D, it will be seen that the engagement of the respective projections 58 of the adaptor plate 56 is as a plug in the socket of each of the separate ports 40 and 42. By this arrangement partially dispensed material in the ports after the mixer head has been used is more likely to be retained within the apertures 60 and 61 of the mixer head when it is removed from the cartridge, thereby minimising the risk of contamination between the two components at the outlets 40 and 42.

When the mixer head and cartridge are prepared for use, the projections 58 on the plate 56 are arranged in registry with the respective ports 40 and 42. These are brought into mutual engagement and the retaining collar 44 is screwed onto the thread of the port member 38 of the cartridge 26. Because the internal diameters of the ports 40 and 42 are the same, and the external diameters of the projections for the apertures 60 and 62 are the same, the mixer head can be mounted on the cartridge in either orientation. At the beginning of dispensing materials from the barrels of the cartridge, they progress at the same velocity through their compensated ports and, thus, enter the mixer head substantially simultaneously and at substantially even pressures. Materials are then mixed as they progress through the static mixer 44 to the outlet of the nozzle 50. Because the internal dimensions of the outlet ports which engage the attachment are the same for all cartridges in a set, the same attachment can be used for any ratio of cartridge barrels in the set.

While it is considered preferable that the projections on the plate 56 should plug into the socket of the outlet ports 40 and 42 of the cartridges, it is possible to arrange this engagement such that the outlet ports 40′ and 42′ on the barrels plug into the apertures defined by the projections 58′ from the plate 56′. This is illustrated in FIGS. 7A-D in which the cross-sectional area of the aperture of the smaller of the two barrels is compensated for by making the wall of the outlet thicker to define an orifice 66 of suitable central circular (not annular) cross-sectional area in the outlet port 40′.

As before, the ports of the two barrels of the cartridge have the same dimension for their engaging surface as that of the engaging surface defining the aperture in the plate 56′. However, in this example the engaging surface is the outer surface of the port which engages with the inner surface defining the aperture in the projection 58′. Again, in this embodiment the mixer head can be assembled onto the cartridge in either orientation. The outlet ports of cartridges at different barrel ratios in a set have the same outer dimensions so that the same attachment can be fitted to each.

In the above description, compensation to enable equal discharge velocities from the barrels of the cartridge is provided by restricting the cross-section area of the outlet of one of the barrels while making the attachment to the cartridge interchangeable across all ratios of barrels in the set. It can be put into effect equally well by increasing the cross section area of the outlet of the larger of the two barrels.

In all the embodiments, the cartridges are made of rigid plastics material such as polypropylene or other suitable rigid plastics material. The cartridge itself is a one piece moulding, including the aperture restriction where appropriate. Likewise, the plate 56 is a one piece moulded part in these embodiments. The static mixers within the nozzle 50 may be a separate insert, or integrally moulded by means of baffle plates projecting from the internal walls of the nozzle itself. Other forms of attachment of the nozzle to the cartridge are possible other than the screw thread arrangement shown. For example, a bayonet type twist-and-lock arrangement could be used or a snap-fit using retaining arms on one of the mixer head and the cartridge that engage complementary ledges on the other of the mixer head and the cartridge. While the retaining collar 44 is shown as a separate item from the integral nozzle and skirt end 50/52, the retaining collar could be integrally moulded as part of a one-piece nozzle. This would require that it rotated relative to the adaptor plate 56 when the nozzle was assembled and removed from the cartridge. Other forms of attachment of the cartridge to the gun are possible, such as by means of a retaining yoke or holster.

It will be appreciated by one of ordinary skill in the art that the invention is susceptible to various other modifications and variations. The above description is provided by way of example and not for the purposes of limitation. The invention is intended to be limited only by the spirit and scope of the following claims.

1.-24. (canceled)

25. A set of two or more multiple barrel cartridges for a multiple component dispenser comprising:
at least two cartridges of different barrel ratios, each cartridge having at least first and second barrels of relatively large and small cross-sectional areas, respectively, each barrel defining an outlet at a first end and having an engaging surface surrounding each of the outlets, the engaging surface being engageable with a corresponding engaging surface of an attachment therefor, the outlets having cross-sectional areas which are relatively large and small in relation to the cross-sectional areas of the barrels, respectively,
wherein an attachment is interchangeable among the set of cartridges.

26. The set of claim 25, wherein the attachment is a mixer head for mixing components discharged from the respective barrel outlets.

27. The set of claim 25, wherein the attachment is a stopper for the barrel outlets.

28. The set of claim 25, wherein each outlet is defined by a corresponding inner wall surface of the cartridge which also constitutes the engaging surface of the outlet, the attachment having projections defining outer wall surfaces which constitute the engaging surface of the attachment.

29. The set of claim 25, wherein the cross-sectional areas of the outlets are in substantially the same ratio as the barrels.

30. The set of claim 25, wherein the engaging surfaces of the outlets of each of the at least two cartridges and the engaging surfaces of the attachment are cylindrical and of substantially a same diameter.

31. The set of claim 25, wherein the engaging surfaces of the attachment are adapted to plug into the outlets.

32. The set of claim 25, wherein the cross-sectional area of the outlet from the relatively small barrel is defined as a ring.

33. The set of claim 32, further comprising a spigot arranged in the outlet of the relatively small barrel.

34. The set of claim 33, wherein the spigot extends for the length of the outlet.

35. The set of claim 33, wherein the spigot is mounted to the engaging surface of the outlet of the relatively small barrel by at least one arm.

36. The set of claim 25, wherein the outlet includes a projection extending from an end wall of each of the barrels.

37. The set of claim 25, wherein the engaging surfaces are separate.

38. An N:1 (N>1) ratio cartridge for a dispenser apparatus comprising:
at least first and second barrels of respectively relatively large (N) and small (1) cross-sectional areas, each barrel having an outlet at a first end and an engaging surface surrounding each of the outlets for engaging a corresponding surface of an attachment, the outlets having cross-sectional areas which are relatively large and small in relation to the cross-sectional areas of the barrels, respectively,
wherein the engaging surfaces of the outlets are of a same shape and lateral dimensions.

39. The cartridge of claim 38, wherein corresponding ratios of the cross-sectional areas of the cartridges and the outlets are substantially the same.

40. The cartridge of claim 38, wherein the outlets are circular.

41. The cartridge of claim 38, wherein the outlet is partially defined by a member arranged in the outlet.

42. The cartridge of claim 41, wherein a cross section of at least one outlet is ring-shaped.

43. The set of claim 38, wherein the attachment is a mixer head defining a common path from the outlets and the mixer head.

44. The cartridge of claim 43, wherein the mixer head includes a spacer member defining apertures in registry with the respective outlets and being engageable with the engaging surfaces, thereby extending the outlet passage into the mixer head.

45. The cartridge of claim 44, wherein each aperture of the spacer is defined by a projection from the spacer which extends into the corresponding outlet from the barrel.

46. The cartridge of claim 38, wherein each barrel comprises an end wall in which the outlet is formed, each outlet having at least partially defined by an outward projection from the end wall.

47. The cartridge of claim 46, wherein the projection has an inner surface defining the outlet and the engaging surface of the outlet is the inner surface of the projection.

48. The set of claim 25, further comprising a dispenser apparatus.

49. The cartridge of claim 38, further comprising a dispense apparatus.
